(19) United States
(12) Patent Application Publication
(10) Pub. No.: US 2006/0001655 A1
(43) Pub. Date: Jan. 5, 2006

(54) Light-transmitting touch panel and detection device

(76) Inventor: Koji Tanabe, Osaka (JP)

Correspondence Address: MCDERMOTT WILL & EMERY LLP, 600 13TH STREET, N.W., WASHINGTON, DC, 20005-3096, US

(21) Appl. No.: 11/171,519

(22) Filed: Jul. 1, 2005

(30) Foreign Application Priority Data
Jul. 1, 2004 (JP) 2004-195193
Feb. 8, 2005 (JP) 2005-031379
Feb. 8, 2005 (JP) 2005-031380

(51) Int. Cl. G09G 5/00

(52) U.S. Cl. 345/176

(57) ABSTRACT

A light-transmitting touch panel and a detection device. The light-transmitting touch panel includes a first substrate where a conductive layer is formed on its back face, and a second substrate where a conductive layer facing the above conductive layer is formed on its surface with a predetermined space in between. A surface conductive layer is formed in a predetermined area on the front face of the first substrate. The detection device detects a proximity of an operator's finger to or a touch on this touch panel. The proximity of a conductive object such as a finger is detectable from a certain distance, and the touched position is also detectable with high accuracy. In addition, sensing of the proximity and sensing of the touched position are clearly distinguishable.

### BACKGROUND OF THE INVENTION

1. Field of the Invention

The present invention relates to light-transmitting touch panels used for operating electronic apparatuses, and to detection devices for detecting the proximity and touch of an operator's finger on light-transmitting touch panels.

2. Background Art

Increasing numbers of electronic apparatuses such as car navigation systems have a light-transmitting touch panel attached to the front face of a display device such as an LCD. In these apparatuses, the user can see characters, symbols and pictures displayed on the display device through the light-transmitting touch panel which is the operating face. At the same time, the user can select and activate characters, etc., by touching the operating face.

In the operation of car navigation systems, in particular, high accuracy is needed for detection of both proximity of the operator's finger to an operating face of the light-transmitting touch panel to a predetermined distance, and the position touched by the finger on the panel face.

A general light-transmitting touch panel of this type is described next with reference to FIGS. 8 and 9. As shown in FIG. 8, a conventional light-transmitting touch panel has light-transmitting substrate 1, made typically of glass. Upper pattern 2, consisting of multiple lines, is made of a conductive material and formed on the front face of substrate 1 parallel to the vertical direction in FIG. 8. The front face of substrate 1 is, for example, the operating face.

Lower pattern 3, consisting of multiple lines, is made of a conductive material and formed on the back face of substrate 1 in a direction perpendicular to upper pattern 2, i.e., parallel to the horizontal direction. This configures the light-transmitting touch panel.

Light-transmitting touch panel 100 as configured above is disposed on the front face of the display device, and attached to an electronic apparatus (not illustrated). In addition, each line of upper pattern 2 and lower pattern 3 is coupled to a sensing circuit (not illustrated) of the electronic apparatus.

When the finger comes close to the operating face of light-transmitting touch panel 100, or the finger touches the operating face, the sensing circuit detects proximity or touched position of the finger by measuring the electrostatic capacity formed between the finger and the opposing pattern.

Next, an example of detecting a position when the finger comes close to around area P1 in FIG. 9 is described. When the finger comes closest to the n-th line in upper pattern 2, the sensing circuit measures the electrostatic capacity between two adjacent lines in a sequence starting from the end of upper pattern 2. Based on measurements of capacity between the (n−1)th and n-th lines, and between the n-th and (n+1)th lines in upper pattern 2 facing the finger, the sensing circuit detects that the finger is closest to the n-th line.

On the other hand, the finger is closest to the m-th line in lower pattern 3. The sensing circuit detects that the finger is closest to the m-th line based on measurements of capacity between the (m−1)th and m-th lines, and between the m-th and (m+1)th lines in lower pattern 3 facing the finger.

As a result, the sensing circuit determines that the proximity position of the finger is an area where the n-th line and the m-th line cross.

In the same way, when the finger touches area P1 on the panel, electrostatic capacity between adjacent lines is measured sequentially, and the area where the n-th line in upper pattern 2 and the m-th line in lower pattern 3 cross is detected as the position touched by the finger.

As described above, the general light-transmitting touch panel is configured to switch diverse functions of electronic apparatus by proximity position and touching position of the finger.

The electrostatic capacity increases in proportion to the size of the area where the finger and pattern oppose, and decreases in inverse proportion to the distance between the finger and pattern where they oppose. In other words, the electrostatic capacity increases as the pattern line width becomes wider and the finger comes closer to the pattern.

The general light-transmitting touch panel as described above is typically disclosed in International Publication number WO 01/027868 A1.

In the above general light-transmitting touch panel, the number of lines in upper pattern 2 and lower pattern 3 need to be increased to improve the detection accuracy of the touched position. However, the pattern line width becomes narrower with increasing number of lines in the pattern, and consequently the capacity to be measured becomes smaller. A smaller capacity makes it difficult to detect the proximity of the finger if the finger is further away from the pattern.

On the other hand, if the pattern line width is widened to detect proximity of the finger at a greater distance, the number of lines in the pattern is reduced, degrading the detection accuracy of the touched position.

Accordingly, in a conventional light-transmitting touch panel, there is a tradeoff between achieving detection of the proximity of a finger at a greater distance and improved detection accuracy of the touched position.

### SUMMARY OF THE INVENTION

The present invention solves the disadvantage of the prior art as described above, and aims to offer a light-transmitting touch panel that shows improved detection capability with respect to both finger proximity distance and touched position, and that can also clearly distinguish between proximity and actual touching.

The light-transmitting touch panel of the present invention includes a transparent and flexible first substrate, a first transparent electrode which is patterned on the first face of the first substrate, a second transparent electrode formed on the second face of the first substrate, a transparent second substrate which faces the first substrate with a predetermined space in between, and a third transparent electrode formed on the second substrate and facing the second transparent electrode. Since the area of the first transparent electrode facing the finger is enlarged, the value of the capacitance of a capacitor formed between the finger and an opposing surface-conductive layer can be increased. The proximity can thus be detected from a greater distance. Presence of touch and the touched position are detected by measuring the voltage ratio while the second transparent electrode and opposing third transparent electrode are in contact. The above configuration offers a light-transmitting touch panel that can detect the proximity of a conductive object such as a finger from a certain distance, that can also detect the touched position with high accuracy, and that can clearly distinguish between detection of proximity and touching.

A detection device of the present invention includes the light-transmitting touch panel and a detector. The light-transmitting touch panel includes a transparent and flexible first substrate with a transparent electrode on both faces, and a second substrate facing the first substrate with a predetermined space in between. This second substrate has a transparent electrode facing the transparent electrodes on the back face of the first substrate. The detector is coupled to at least the transparent electrode on the front face, and includes a sensing circuit for detecting the proximity of a conductive object to the first substrate and a sensing circuit for detecting a contact of the first substrate and second substrate. This offers a detection device that can detect the proximity of a conductive object such as a finger and that can also detect the presence and position of a touch with a high degree of accuracy.

Still more, the detection device of the present invention includes the light-transmitting touch panel and detector. The light-transmitting touch panel has a transparent and flexible first substrate, the first transparent electrode patterned on the first face of the first substrate, the second transparent electrode formed on the second face of the first substrate, the transparent second substrate facing the first substrate with a predetermined space in between, and the third transparent electrode formed on the second substrate and facing the second transparent electrode. The detector has a capacitance-sensing circuit coupled to at least the first transparent electrode, and a voltage ratio-sensing circuit for detecting a contact of the second transparent electrode and third transparent electrode. This offers a detection device that can detect the proximity of a conductive object such as a finger and that can also detect the presence and position of a touch with a high degree of accuracy.

The detection device of the present invention is further provided with an alarm that generates sound, light, vibration, etc., in response to proximity or touch of a conductive object. For example, when the operator moves the finger close to an intended display on a display device, the detector detects the proximity of this finger and outputs a detection signal to the alarm. The alarm, on receiving this signal, generates sound, light, vibration, etc., such that the operator does not have to visually check the display every time. The operator can simply move the finger close to the intended display for confirming the display.

Accordingly, the present invention offers a light-transmitting touch panel that can detect the proximity of a conductive object such as a finger from a certain distance, that can also detect the touched position with high accuracy, and that can clearly distinguish between detection of proximity and touch.

### BRIEF DESCRIPTION OF THE DRAWINGS

FIG. 1 is a sectional view of a light-transmitting touch panel in accordance with a first exemplary embodiment of the present invention.

FIG. 2 is a plan view of the light-transmitting touch panel in accordance with the first exemplary embodiment of the present invention.

FIG. 3 is a schematic diagram illustrating touching of the light-transmitting touch panel in accordance with the first exemplary embodiment of the present invention.

FIGS. 4A and 4B are schematic diagrams of a capacitance-sensing method in the light-transmitting touch panel in accordance with the first exemplary embodiment of the present invention.

FIGS. 5A and 5B are schematic diagrams of the capacitance-sensing method in a light-transmitting touch panel in accordance with a second exemplary embodiment of the present invention.

FIG. 6 is a sectional view of a light-transmitting touch panel in accordance with a third exemplary embodiment of the present invention.

FIG. 7 is a plan view of the light-transmitting touch panel in accordance with the third exemplary embodiment of the present invention.

FIG. 8 is a sectional view of a general light-transmitting touch panel.

FIG. 9 illustrates a configuration of upper and lower patterns of the light-transmitting touch panel.

### DETAILED DESCRIPTION OF THE INVENTION

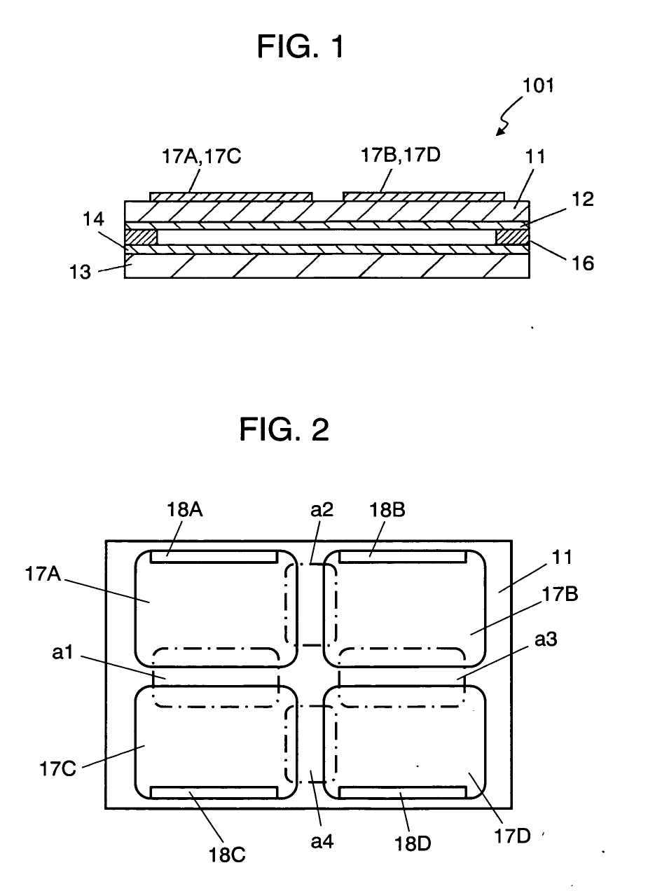

FIG. 1 is a sectional view of light-transmitting touch panel 101 in the first exemplary embodiment of the present invention. Light-transmitting touch panel 101 includes light-transmitting top substrate 11 (equivalent to the first substrate) and light-transmitting upper conductive layer 12 (equivalent to the second transparent electrode) formed on its back face. Top substrate (first substrate) 11 is typically made of a transparent resin film such as polyethylene terephthalate and polycarbonate. Upper conductive layer 12 is a light-transmitting conductive film typically made of indium tin oxide, using vacuum deposition or sputtering.

A pair of upper electrodes (not illustrated) is formed by printing paste, typically containing silver or carbon, on both ends of this upper conductive layer 12.

On the surface of light-transmitting bottom substrate 13 (equivalent to the second substrate) made such as of glass, acryl1ic resin or polycarbonate resin, light-transmitting lower conductive layer 14 (equivalent to the third transparent electrode), typically made of indium tin oxide, is formed using the same method as that for upper conductive layer 12.

On the surface of this lower conductive layer 14, a pair of lower electrodes (not illustrated), the same as the upper electrodes, is disposed on both ends in a direction perpendicular to the upper electrodes. In addition, dot spacers (not illustrated) are formed at predetermined intervals so as to secure a predetermined space between lower conductive layer 14 and upper conductive layer 12.

An adhesive layer (not illustrated) made of thermoplastic resin is applied on the front face and back face of frame spacer 16, typically made of nonwoven fabric or polyester film.

Top substrate 11 and bottom substrate 13 are then attached at their peripheries via spacer 16 in such a way that upper conductive layer 12 and lower conductive layer 14 face each other with a predetermined space in between.

Light-transmitting surface-conductive layers 17A to 17D (equivalent to the first transparent electrode), typically made of indium tin oxide, are formed in predetermined areas on the front face of top substrate 11, typically by vacuum sputtering.

FIG. 2 is a plan view of light-transmitting touch panel 101 seen from the operating side. As shown in FIG. 2, surface-conductive layers 17A to 17D are formed in planar fashion in predetermined areas at the upper left, upper right, lower left and lower right on the front face of top substrate 11. Upper left electrode 18A, upper right electrode 18B, lower left electrode 18C and lower right electrode 18D are disposed on the ends of predetermined areas of each of surface-conductive layer by printing paste made such as of silver and carbon. Light-transmitting touch panel 101 is thus structured.

A detection device in the first exemplary embodiment includes aforementioned light-transmitting touch panel 101; and a detector (not illustrated) coupled to each electrode of surface-conductive layers 17A to 17D, upper conductive layer 12 and lower conductive layer 14 of light-transmitting touch panel 101. A capacitance-sensing circuit is coupled between surface-conductive layers 17A to 17D and upper conductive layer 12. A voltage ratio-sensing circuit is coupled to upper conductive layer 12 and lower conductive layer 14. In addition, an alarm (not illustrated) can be coupled to the detector. The detector can be configured with semiconductor devices such as microcomputers, electrical circuits, and so on. The alarm can be configured to include audio equipment such as a buzzer or a speaker; lighting equipment such as a light-emitting diode and a lamp; or a vibrator such as motor or piezoelectric buzzer.

The light-transmitting touch panel as configured above is disposed on the surface of a display device of, for example, a car navigation apparatus. The detector and alarm are built into the car navigation apparatus, and the detector is coupled to a control circuit (not illustrated) of the car navigation apparatus.

The operation of the detection device employing light-transmitting touch panel 101 of the present invention is described next, taking an example of employing the detection device of the exemplary embodiment and a display unit in a car navigation apparatus.

In the detection device, the capacitance-sensing circuit repetitively detects a capacitance between surface-conductive layers 17A, 17B, 17C and 17D, and upper conductive layer 12 respectively and in turn.

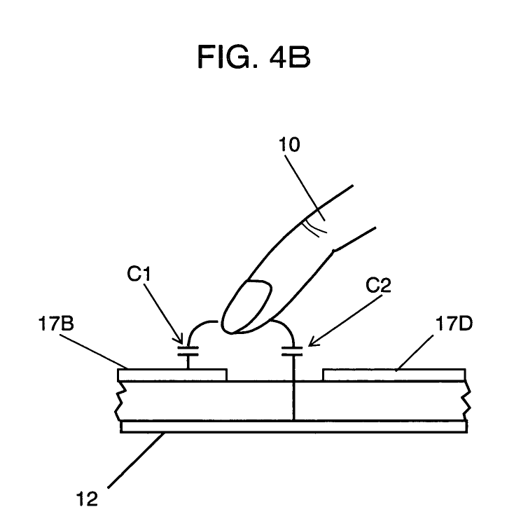

When finger 10 is not in proximity, as shown schematically in FIG. 4A, capacitance C0 is detected between surface-conductive layers 17B or 17D and upper conductive layer 12.

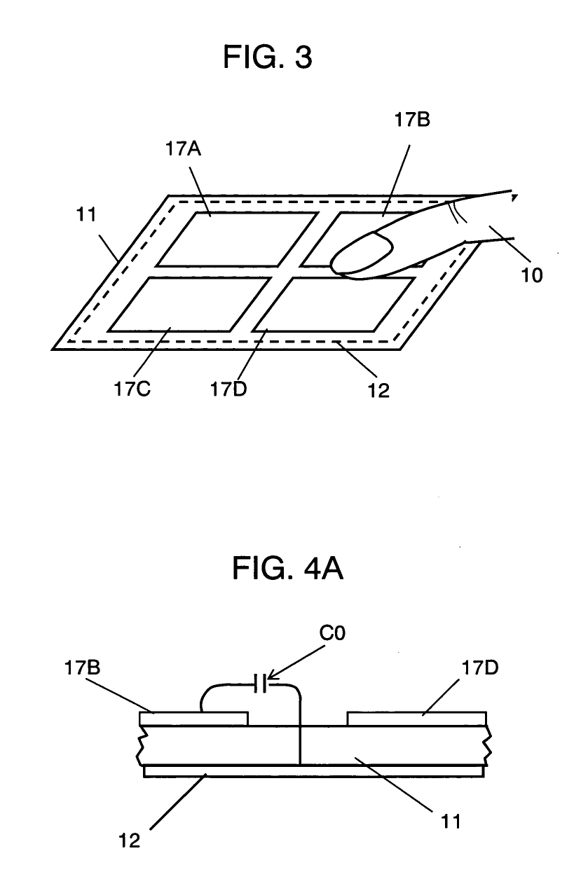

Next, FIG. 3 shows the state where the operator sees a display on the display device disposed on the back face of light-transmitting touch panel 101 and moves a finger over light-transmitting touch panel 101 close to area a3 (the border between surface-conductive layers 17B and 17D as shown in FIG. 2).

In this state, a capacitor with capacitance C1 is formed between finger 10 and a portion of surface-conductive layer 17B facing finger 10, and thus a capacitor with capacitance C2 is created between upper conductive layer 12 and finger 10. This capacitor, which is newly created when finger 10 comes in proximity to panel 101, increases the capacitance detected between surface-conductive layer 17B and upper conductive layer 12.

The capacitance-sensing circuit detects the proximity of finger 10 to surface-conductive layer 17B by detecting the difference in the measured capacitance. “Proximity” in the description refers to a distance of within 15 mm from the finger to the top substrate. In addition, a weak touch by a conductive object, such as a finger, which does not dent the top substrate, is also included in “proximity.” On the contrary, “touch” is a state in which the conductive object bents the top substrate so that upper conductive layer 12 comes in contact with lower conductive layer 14.

As shown in FIG. 2, surface-conductive layer 17B is formed not linearly but in a plane, and thus a capacitor is formed between the area of the finger and a portion of surface-conductive layer 17B facing the finger which has the size equivalent to the area of the finger. Accordingly, the capacitance to be added can be made greater.

The sensing circuit detecting the proximity of the finger transmits a detection signal to the alarm. The alarm, on receiving this detection signal, generates a “bleep, bleep!” sound, and light or vibration, etc., simultaneously with the sound. This notifies the driver of the proximity of the finger to surface-conductive layer 17B in area a3.

When the operator, such as the driver or a passenger, moves finger 10 close to areas a1, a2 or a4, the capacitance-sensing circuit detects an increase in capacitance in the same way. More specifically, the capacitance-sensing circuit detects the proximity of a finger to a border area of surface-conductive layer 17A, 17B, 17C or 17D, and the detection signal corresponding to the respective border area is transmitted to the alarm.

The alarm, on receiving the detection signal corresponding to each of these areas, can separately notify the operator to which of surface-conductive layers 17A, 17C and 17D the finger is in proximity. For example, when finger 10 is close to surface-conductive layer 17A, the alarm makes a “bleep!” sound. When finger 10 is close to surface-conductive layer 17C, the alarm makes three consecutive sounds, such as “bleep, bleep, bleep!” In the same way, when finger 10 is close to surface-conductive layer 17D, the alarm makes four consecutive sounds of “bleep, bleep, bleep, bleep!” Moreover, instead of or in addition to these sounds, lighting, vibration, and so on can be generated.

In other words, the operator does not need to visually check the display every time, since the capacitance-sensing circuit detects the rough proximity position and the alarm generates sound, light, vibration, and so on corresponding to the proximity position when the operator moves a finger close to the surface of the display on the display device. The operator can therefore confirm the intended display just by moving the finger close to its surface.

Then, when the operator touches any portion of surface-conductive layer 17B with a finger, top substrate 11 dents, and the portion of upper conductive layer 12 corresponding to the touched position contacts lower conductive layer 14. A voltage ratio-sensing circuit can thus detect when the panel is being touched. In other words, the detector clearly distinguishes between detection of touch and proximity. The voltage ratio-sensing circuit further applies a voltage between upper conductive layer 12 and lower conductive layer 14, and detects the exact position touched on first conductive layer 17B by detecting the voltage ratio in upper conductive layer 12 and in lower conductive layer 14.

Accordingly, if, for example, a display on the display device of the car navigation apparatus opposing the surface-conductive layer 17B is a switch for “traffic information,” the driver can confirm that his/her finger is pointing at “traffic information” just by confirming the sound such as “bleep, bleep!” made when moving the finger close to the surface.

After the driver confirms that his/her finger is in proximity to “traffic information,” the driver can move the finger closer in the same direction and touch surface-conductive layer 17B. The sensing circuit then detects which portion of this surface-conductive layer 17B is being touched, and transmits a signal to the control circuit of the car navigation apparatus. Consequently, for example, the control circuit outputs “traffic information” in the form of sound through a speaker so that the driver and passengers can listen to “traffic information.”

In the above description, surface-conductive layers 17A to 17D are formed in predetermined areas on top substrate 11. Alternatively, the present invention is also achievable by forming a surface-conductive layer over the entire front face of top substrate 11.

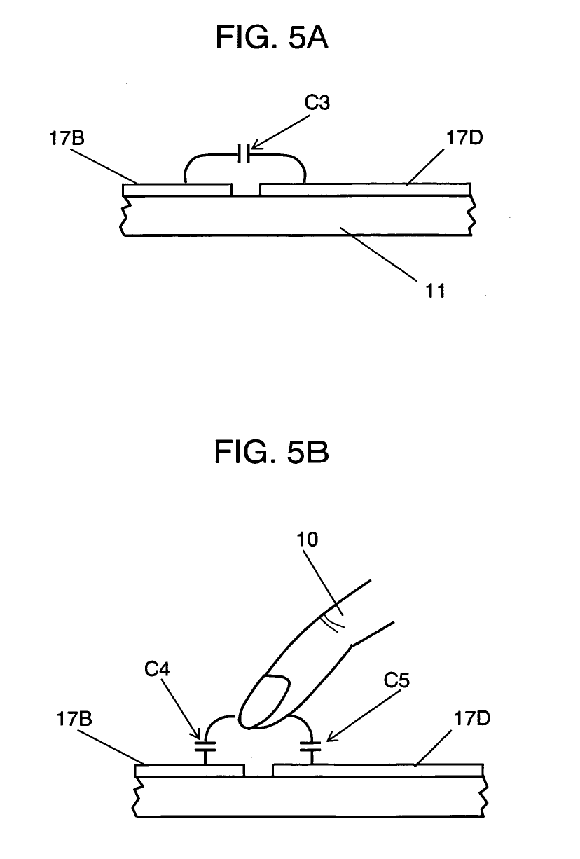

FIGS. 5A and 5B show the second exemplary embodiment of the present invention. The second exemplary embodiment also employs light-transmitting touch panel 101 in the first exemplary embodiment.

A detection device in the second exemplary embodiment is configured including aforementioned light-transmitting touch panel 101; and a detector (not illustrated) configured including a microcomputer and coupled to each electrode of surface conductive layers 17A to 17D, upper conductive layer 12 and lower conductive layer 14 of this light-transmitting touch panel 101. The capacitance-sensing circuit is coupled to surface conductive layers 17A to 17D, and the voltage ratio-sensing circuit is coupled to upper conductive layer 12 and lower conductive layer 14. In addition, an alarm (not illustrated) can be coupled to the detector.

The light-transmitting touch panel as configured above is disposed on the surface of a display device of, for example, a car navigation apparatus. The detector and alarm are built into the car navigation apparatus, and the detector is coupled to a control circuit (not illustrated) of the car navigation apparatus.

The operation of the detection device employing light-transmitting touch panel 101 of the present invention is described next, taking an example of employing the detection device of the exemplary embodiment and a display unit in a car navigation apparatus.

In the detection device, the capacitance-sensing circuit detects a capacitance between two adjacent surface conductive layers in surface conductive layers 17A, 17B, 17C and 17D respectively and in turn.

FIGS. 3, 5A and 5B show the state where the operator sees a display on the car navigation apparatus and moves finger 10 close to area a3 between surface-conductive layers 17B and 17D. When finger 10 is not in proximity, electrostatic capacitance C3 formed between surface conductive layers 17B and 17D is measured between upper right electrode 18B and lower right electrode 18D, as shown in FIG. 5A.

Next, FIG. 5B shows the state that finger 10 is in proximity to area a3 at a distance within 15 mm. In this case, a combined capacitance including capacitance C4 formed between finger 10 and opposing surface conductive layer 17B and electrostatic capacitance C5 formed between finger 10 and surface conductive layer 17D is measured between upper right electrode 18B and lower right electrode 18D. Accordingly, whether finger 10 is in proximity to area a3 is detectable by detecting the change in capacitance between upper right electrode 18B and lower right electrode 18D.

The sensing circuit then outputs a detection signal to the alarm. The alarm, on receiving this detection signal, generates a “bleep, bleep, bleep!” sound, and light or vibration, etc., simultaneously with the sound. This notifies the operator of the proximity of the finger to area a3.

When the operator moves a finger close to areas a1, a2 or a4, the capacitance-sensing circuit also measures an increase in capacitance between adjacent surface conductive layers in the same way, and detects the proximity of a finger. Then, the detection signal corresponding to the respective area is transmitted to the alarm.

For example, as described in the first exemplary embodiment, the alarm makes a “bleep!”, “bleep, bleep!” or “bleep, bleep, bleep, bleep!” sound according to detecting the proximity of a finger to areas a1, a2 or a4, and light, vibration, etc., simultaneously with the sound so as to notify the operator.

In other words, the operator does not need to visually check the display every time, since the capacitance-sensing circuit detects the proximity of finger and the alarm generates sound, light, vibration, and so on when the operator moves a finger close to the display.

Then, for example, if the operator touches any portion in area a1 with a finger, top substrate 11 dents, and the portion of upper conductive layer 12 corresponding to the touched position lower conductive layer 14. The voltage ratio-sensing circuit can thus detect when the panel is being touched. In other words, the detector clearly distinguishes between detection of touch and proximity. The voltage ratio-sensing circuit further applies a voltage between upper conductive layer 12 and lower conductive layer 14, and detects the exact position touched by detecting the voltage ratio in upper conductive layer 12 and in lower conductive layer 14.

Accordingly, if, for example, a display on the display device of the car navigation apparatus in area a1 is a switch for “highway information,” the operator can confirm that his/her finger is pointing at the area of “highway information” just by confirming the sound such as “bleep!” made when moving the finger close to the surface.

After the operator confirms that his/her finger is in proximity to “highway information,” the operator can move the finger closer in the same direction and touch area a1. The sensing circuit then detects the portion touched, and transmits a detection signal to the control circuit of the car navigation apparatus. Consequently, for example, the control circuit outputs “highway information” in the form of sound so that the operator can listen to “highway information.”

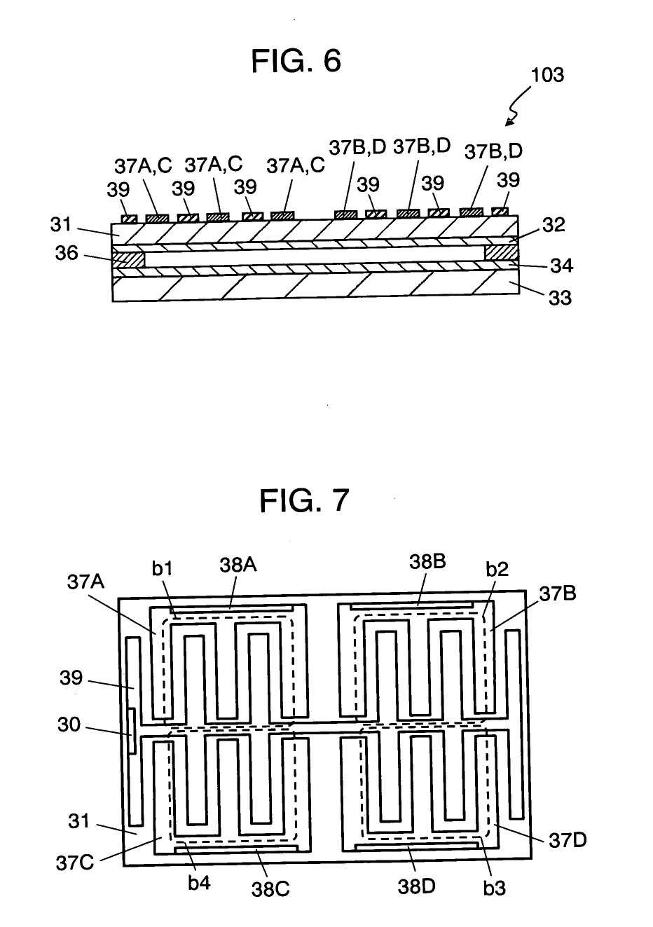

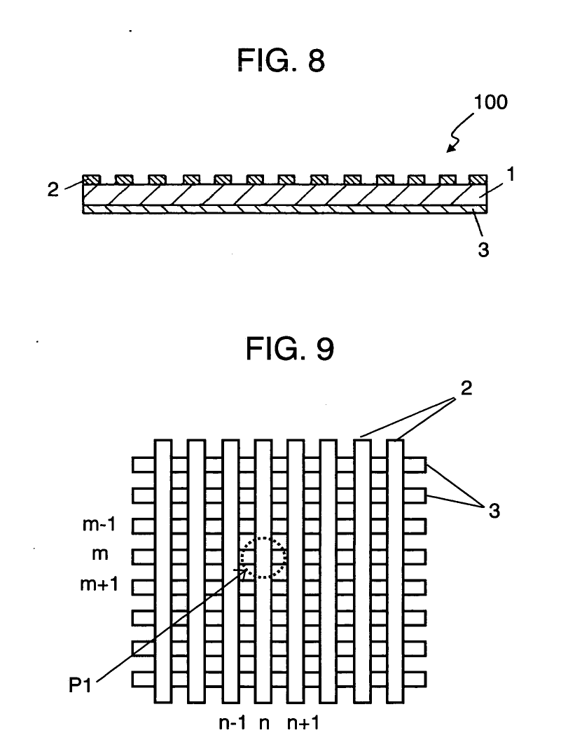

FIGS. 6 and 7 show the third exemplary embodiment of the present invention. Description on the configuration same as the first exemplary embodiment is simplified.

FIG. 6 is a sectional view of light-transmitting touch panel 103 in the third exemplary embodiment. As shown in FIG. 6, light-transmitting upper conductive layer 32 is formed on the back face of light-transmitting top substrate 31 (equivalent to the first substrate).

Upper electrodes (not illustrated) are formed on both ends of this upper conductive layer 32 (equivalent to the second transparent electrode) by printing using conductive paste.

Light-transmitting lower conductive layer 34 (equivalent to the third transparent electrode) is formed on the surface of light-transmitting bottom substrate 33 (equivalent to the second substrate).

On the surface of this lower conductive layer 34, lower electrodes (not illustrated) are formed on both ends in a direction perpendicular to the upper electrodes. Dot spacers (not illustrated) are also provided on this face at predetermined intervals so as to secure a predetermined space between lower conductive layer 34 and upper conductive layer 32.

An adhesive layer (not illustrated) made of thermoplastic resin is applied on the front face and back face of frame spacer 36.

Top substrate 31 and bottom substrate 33 are then attached at their peripheries via spacer 36 in such a way that upper conductive layer 32 and lower conductive layer 34 face each other with a predetermined space in between.

Light-transmitting surface conductive layers 37A to 37D and 39 (equivalent to the first transparent electrode) are formed in a predetermined area on the front face of top substrate 31.

FIG. 7 is a plan view of light-transmitting touch panel 103 seen from the operating side. Comb-like surface conductive layers 37A to 37D are formed in predetermined areas at the left, right, top and bottom on the front face of top substrate 31 in such a way that to make a pair with comb-like central surface conductive layer 39 respectively. Upper electrodes 38A and 38B, lower electrodes 38C and 38D and central electrode 30 made by printing conductive paste are disposed on a part of surface conductive layers 37A to 37D and central surface conductive layer 39. This completes light-transmitting touch panel 103.

A detection device in the third exemplary embodiment includes aforementioned light-transmitting touch panel 103; and a detector (not illustrated) configured including a microcomputer and coupled to each electrode of surface-conductive layers 37A to 37D and 39, upper conductive layer 32 and lower conductive layer 34 of light-transmitting touch panel 103. A capacitance-sensing circuit is coupled between surface-conductive layers 37A to 37D and central surface conductive layer 39. A voltage ratio-sensing circuit is coupled to upper conductive layer 32 and lower conductive player 34. In addition, an alarm (not illustrated) can be coupled to the detector.

The light-transmitting touch panel as configured above is disposed on the surface of a display device of, for example, a car navigation apparatus. The detector and alarm are built into the car navigation apparatus, and the detector is coupled to a control circuit (not illustrated) of the car navigation apparatus.

The operation of the detection device employing light-transmitting touch panel 103 of the present invention is described next, taking an example of employing the detection device of the exemplary embodiment and a display unit in a car navigation apparatus.

In the detection device, the capacitance-sensing circuit repetitively detects a capacitance between central surface conductive layer 39 and each surface-conductive layers 37A, 37B, 37C and 37D, in turn.

When the operator sees a display on the car navigation apparatus, and moves a finger close to area b1 where surface conductive layer 37A and central surface conductive layer 39 are adjacent each other, a capacitor is formed between the finger and a portion of surface conductive layer 37A and central surface conductive layer 39 facing the finger. A resultant change in capacitance is measured between their upper left electrode 38A and central electrode 30. The capacitance-sensing circuit thus detects that the finger is in proximity to area b1 by comparing with the state that the finger is not in proximity. This detection method is the same as that described in the second exemplary embodiment.

The sensing circuit then transmits a detection signal to the alarm. The alarm, on receiving this detection signal generates a “bleep!” sound, for example, and light, vibration, etc., simultaneously with the sound. This notifies the operator of the proximity of the finger to area b1.

When the operator moves the finger close to areas b2, b3 or b4, the capacitance-sensing circuit also detects an increase in capacitance in the same way. The capacitance-sensing circuit detects the proximity of a finger, and the detection signal corresponding to the respective area is transmitted to the alarm.

For example, as described in the first exemplary embodiment, the alarm generates “bleep, bleep!,” “bleep, bleep, bleep!,” or “bleep, bleep, bleep, bleep!,” and lighting, vibration, and so on instead of or in addition to these sounds so as to notify the operator.

In other words, the operator does not need to visually check the display every time for confirmation, since the sensing circuit detects the proximity position and the alarm generates sound, light, vibration, and so on corresponding to the proximity position when the operator moves a finger close to the surface of the display.

Then, when the operator touches any portion in area b1 with a finger, top substrate 31 dents, and the portion of upper conductive layer 32 corresponding to the touched position contacts lower conductive layer 34. A voltage ratio-sensing circuit can thus detect when the panel is being touched clearly distinguishing from the proximity of finger 10. The voltage ratio-sensing circuit further applies a voltage between upper conductive layer 32 and lower conductive layer 34, and detects the exact position pushed by detecting the voltage ratio in upper conductive layer 32 and in lower conductive layer 34.

In particular, in the third exemplary embodiment, surface conductive layers 37A to 37D respectively face central surface conductive layer 39 in a comb shape. This configuration allows detection of proximity to area b1, for example, when a finger is in proximity to any border area between surface conductive layer 37A and central surface conductive layer 39 within area b1. This improves operability and reduces erroneous operation.

Accordingly, if, for example, a display on the display device of the car navigation apparatus opposing area b1 is a switch for “map information,” the operator can confirm that his/her finger is pointing at “map information” just by confirming the sound such as “bleep!” made when moving the finger close to the surface.

After the operator confirms that his/her finger is pointing at “map information,” the operator can move the finger closer in the same direction and touch area b1. The sensing circuit then detects which portion is being touched, and transmits a detection signal to the control circuit of the car navigation apparatus. Consequently, for example, the control circuit outputs “map information” in the form of sound so that the operator can listen to “map information.”

As described above, the detection device of the present invention includes the light-transmitting touch panel of the present invention and the detector. The light-transmitting touch panel has one or more divided first transparent electrodes on an operating face of a general touch panel. The detection device includes both proximity sensing circuit for detecting the proximity of a conductive object to the first transparent electrodes and a sensing circuit for detecting a contact of upper and lower electrodes of the touch panel. This configuration offers a detection device that can detect the proximity of a conductive object, such as a finger, from a certain distance, and can also detect the presence of a touch and its position with high accuracy.

Still more the present invention can be combined with an alarm which generates sound, light, vibration, and so on. For example, when the operator uses a car navigation apparatus, the detection device detects the proximity of operator's finger, and the alarm generates sound, light, vibration, and so on. This eliminates the need of visual confirmation. In other words, the present invention can detect the proximity of a conductive object such as a finger from a certain distance, that can also detect the touched position with a high degree of accuracy, and that can clearly distinguish between detection of proximity and touch. Accordingly, the present invention is advantageous for a range of electronic apparatuses.

What is claimed is:

1. A light-transmitting touch panel comprising:
a transparent and flexible first substrate;
a first transparent electrode patterned on a first face of the first substrate;
a second transparent electrode formed on a second face of the first substrate;
a transparent second substrate facing the first substrate with a predetermined space in between; and
a third transparent electrode formed on the second substrate, the third transparent electrode facing the second transparent electrode.

2. The light-transmitting touch panel as defined in claim 1, wherein the first transparent electrode comprises at least a pair of comb electrodes facing each other.

3. A detection device comprising a light-transmitting touch panel and a detector,
the light-transmitting touch panel comprising:
a transparent and flexible first substrate having a transparent electrode on both front face and back face; and
a second substrate having a transparent electrode facing the transparent electrode on the back face, the second substrate facing the first substrate with a predetermined space in between; and
the detector comprising:
a sensing circuit for detecting a proximity of a conductive object to the first substrate, the sensing circuit being coupled to at least the transparent electrode on the surface; and
a sensing circuit for detecting a contact of the first substrate and the second substrate.

4. The detection device as defined in claim 3, further comprising an alarm,
wherein the detector detects a proximity of the conductive object, transmits an electrical signal to the alarm, and activates the alarm.

5. A detection device comprising a light-transmitting touch panel and a detector,
the light-transmitting touch panel comprising:
a transparent and flexible first substrate;
a first transparent electrode patterned on a first face of the first substrate;
a second transparent electrode formed on a second face of the first substrate;
a transparent second substrate facing the first substrate with a predetermined space in between; and
a third transparent electrode formed on the second substrate, the third transparent electrode facing the second transparent electrode; and
the detector comprising:
a capacitance-sensing circuit coupled to at least the first transparent electrode; and
a voltage ratio-sensing circuit for detecting a contact of the second transparent electrode and the third transparent electrode.

6. The detection device as defined in claim 5, further comprising an alarm,
wherein the detector detects a proximity of the conductive object to the first transparent electrode, transmits an electrical signal to the alarm, and activates the alarm.

7. The detection device as defined in claim 5,
wherein the first transparent electrode consists of a plurality of divided electrodes; and
the detector is coupled to at least the plurality of divided electrodes, and detects a change in capacitance between the divided electrodes in line with a proximity of a conductive object to the divided electrodes.

8. The detection device as defined in claim 5,
wherein the first transparent electrode consists of a plurality of divided electrodes; and
the detector is coupled to at least the plurality of divided electrodes, and detects a change in capacitance in the adjacent divided electrodes in line with a proximity of a conductive object to an area of the adjacent divided electrodes.

9. The detection device as defined in claim 5,
wherein the first transparent electrode comprises at least a pair of comb electrodes facing each other; and
the detector is coupled to at least each of the pair of comb electrodes, and detects a change in capacitance between the comb electrodes in line with a proximity of a conductive object to the pair of adjacent comb electrodes.

10. The detection device as defined in claim 5, further comprising an alarm,
wherein the first transparent electrode comprises at least a pair of adjacent comb electrodes; and
the detector is coupled to at least each of the pair of comb electrodes,
wherein the detector generates a signal at detecting a change in capacitance between the comb electrodes in line with a proximity of a conductive object to the pair of adjacent comb electrodes,
transmits the signal to the alarm, and
activates the alarm.
